(19) United States
(12) Patent Application Publication
(10) Pub. No.: US 2025/0379755 A1
(43) Pub. Date: Dec. 11, 2025

(54) AUTHENTICATION SYSTEMS AND METHODS FOR ELECTRONICS PACKAGING

(71) Applicant: Purdue Research Foundation, West Lafayette, IN (US)

(72) Inventors: Alexander V. Kildishev, West Lafayette, IN (US); Blake Anthony Wilson, Reading (GB); Yuheng Chen, West Lafayette, IN (US); Daksh Kumar Singh, West Lafayette, IN (US); Rohan Ojha, Rockville, MD (US); Michael Bezick, West Lafayette, IN (US); Alexandra Boltasseva, West Lafayette, IN (US); Vladimir M. Shalaev, West Lafayette, IN (US)

(73) Assignee: Purdue Research Foundation, West Lafayette, IN (US)

(21) Appl. No.: 19/233,515

(22) Filed: Jun. 10, 2025

Related U.S. Application Data
(60) Provisional application No. 63/658,599, filed on Jun. 11, 2024.

(51) Int. Cl. H04L 9/32

(52) U.S. Cl. CPC H04L 9/3278

(57) ABSTRACT

An authentication system for semiconductor devices using gold nanoparticle-based physical unclonable functions (PUFs). The system captures dark-field microscopy images of randomly distributed gold nanoparticles on semiconductor packaging, extracts nanoparticle patterns through semantic segmentation and clustering, and authenticates devices by comparing distance matrices between initial and subsequent measurements. The system's machine learning approach distinguishes between natural degradation and malicious tampering, outperforming traditional authentication metrics.

### CROSS REFERENCE TO RELATED APPLICATIONS

This application claims the benefit of U.S. Provisional Application No. 63/658,599 filed Jun. 11, 2024, the entirety of which is hereby incorporated by reference.

### FIELD OF THE DISCLOSURE

Embodiments of the present disclosure relate generally to semiconductor authentication and, more particularly, to systems and methods for detecting counterfeit or tampered electronic devices using physical unclonable functions based on random arrays of gold nanoparticles.

### BACKGROUND OF THE DISCLOSURE

The semiconductor industry has grown into a $500 billion global market over the last 60 years. However, the semiconductor fabrication pipeline has become fragmented, inadvertently giving rise to a $75 billion counterfeit chip market that jeopardizes safety and security across multiple sectors dependent on semiconductor technologies, such as aviation, communications, quantum computing, artificial intelligence, and personal finance.

Several techniques aimed at affirming semiconductor authenticity have been introduced to detect counterfeit chips, largely leveraging physical security tags embedded into the chip functionality or packaging. Central to many of these methods are physical unclonable functions (PUFs), which are unique physical systems that are difficult to replicate either because of economic constraints or inherent physical properties. Rather than being grounded in cryptographic hardness, PUFs emphasize the economic and technological challenges of duplicating a given system's physical characteristics.

Optical PUFs, which capitalize on the distinct optical responses of random media, are especially promising. However, achieving scalability and maintaining accurate discrimination between adversarial tampering and natural degradation, such as physical aging at higher temperatures, packaging abrasions, and humidity, poses challenges.

Current verification methods for distance matrix PUFs are neither sufficiently scalable nor robust enough for discriminating between natural disturbances and adversarial tampering, creating a need for more robust authentication systems and methods.

### BRIEF SUMMARY OF THE DISCLOSURE

Embodiments of the present disclosure relate to systems and methods for authenticating semiconductor devices using physical unclonable functions (PUFs) formed by randomly distributed gold nanoparticles. The authentication method addresses the dual challenges faced by the global chip industry: a profound shortage of new chips and a surge of counterfeit chips valued at $75 billion, which introduce substantial risks of malfunction and unwanted surveillance.

To counter these risks, embodiments of the present disclosure provide an optical anti-counterfeit detection method for semiconductor devices that is robust against adversarial tampering features such as malicious package abrasions, compromised thermal treatment, and adversarial tearing. The method employs a deep learning approach using a RAPTOR (Residual, Attention-based Processing of Tampered Optical Response) discriminator, which demonstrates the capability of identifying adversarial tampering by comparing optical responses between an initial state and a potentially altered state.

The RAPTOR approach leverages semantic segmentation and labeled clustering to efficiently extract the positions and radii of gold nanoparticles arranged in random patterns. This extraction process is performed on dark-field microscopy images, allowing rapid verification of authenticity with high accuracy even under difficult adversarial tampering conditions.

The systems and methods disclosed herein outperform traditional authentication approaches based on Hausdorff, Procrustes, and average Hausdorff distance metrics, achieving substantially improved accuracy for detecting tampered semiconductor devices. The novel approach is particularly effective at distinguishing between natural degradation and malicious tampering.

Having thus described embodiments of the present disclosure in general terms, reference will now be made to the accompanying drawings, which are not necessarily drawn to scale, and wherein:

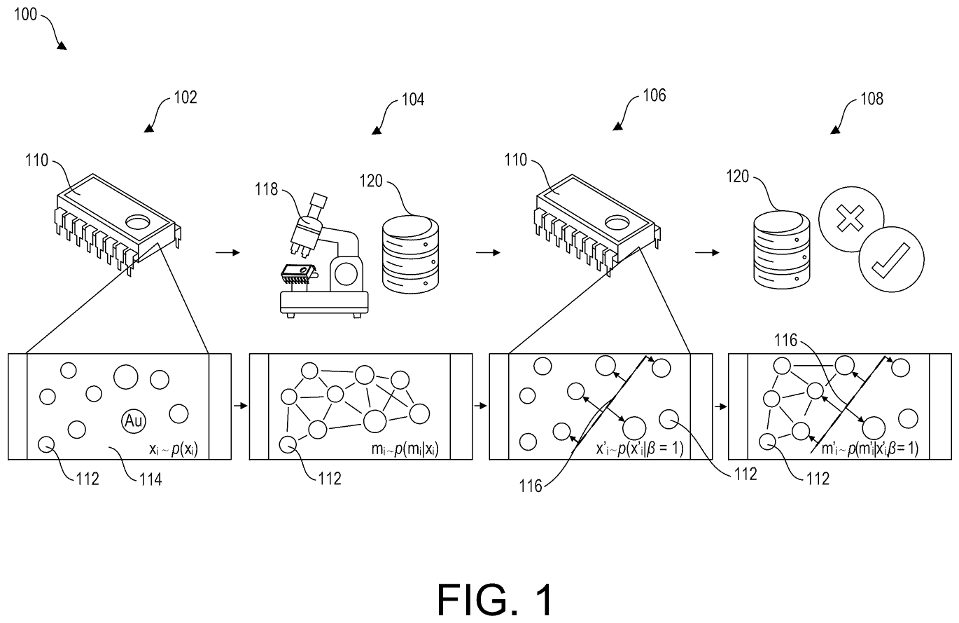

FIG. 1 illustrates a physical unclonable function (PUF) sampling process according to an example embodiment of the present disclosure;

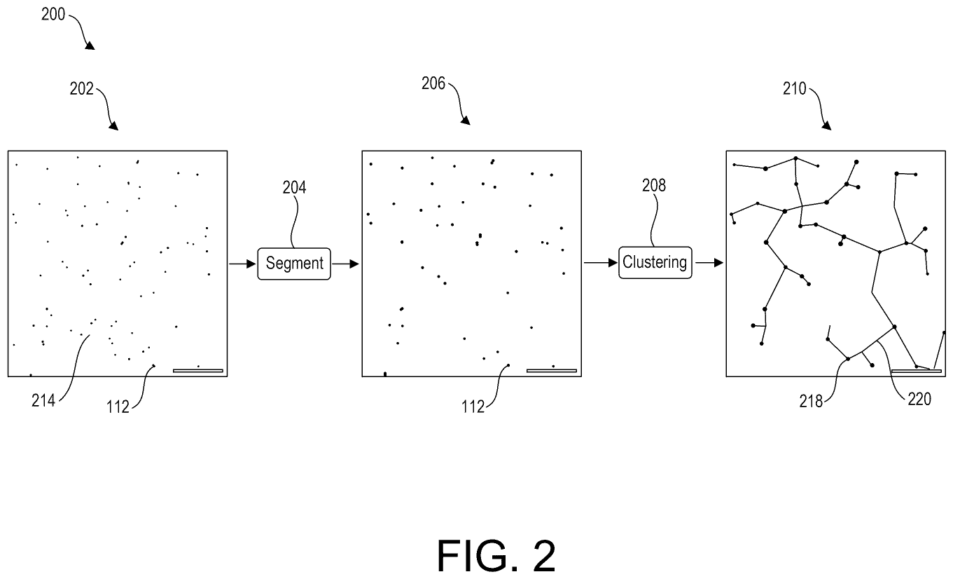

FIG. 2 illustrates a distance matrix extraction process according to an example embodiment of the present disclosure;

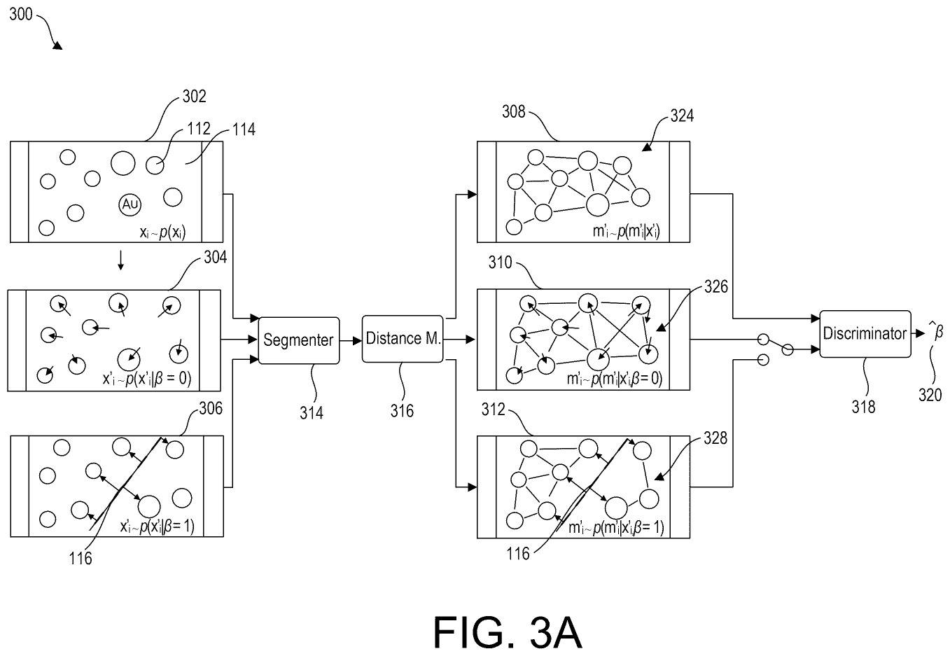

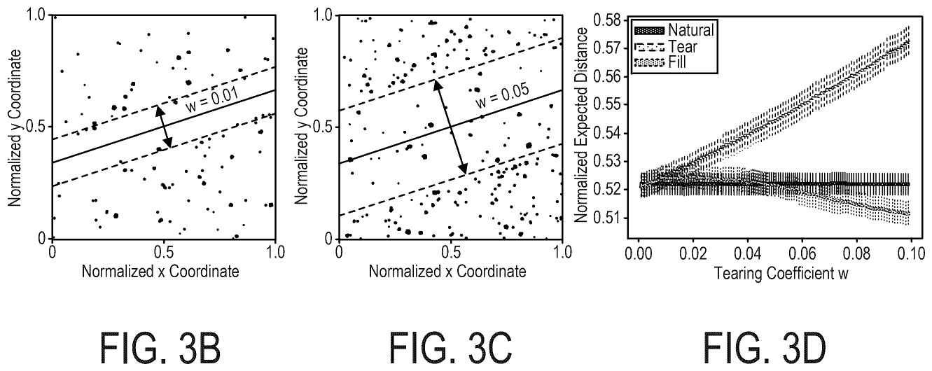

FIG. 3A illustrates a machine learning authentication flow according to an example embodiment of the present disclosure;

FIG. 3B illustrates a low tearing coefficient example showing gold nanoparticles and a tear line with displacement vectors according to an example embodiment of the present disclosure;

FIG. 3C illustrates a high tearing coefficient example showing gold nanoparticles and a tear line with more pronounced displacement vectors according to an example embodiment of the present disclosure;

FIG. 3D is a normalized expected distance graph showing the natural degradation, tear without filling, and tear with filling plotted against the tearing coefficient and normalized expected distance according to an example embodiment of the present disclosure;

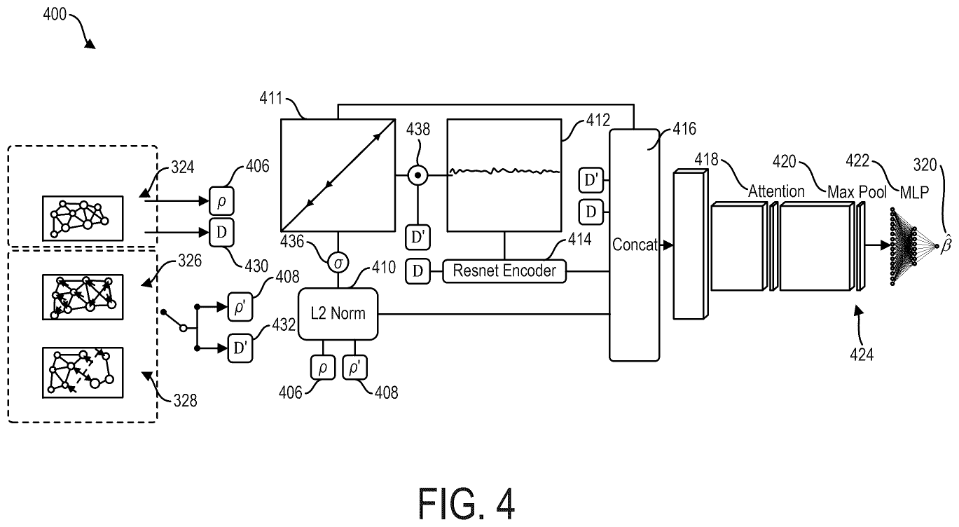

FIG. 4 illustrates a residual, attention-based processing architecture according to an example embodiment of the present disclosure.

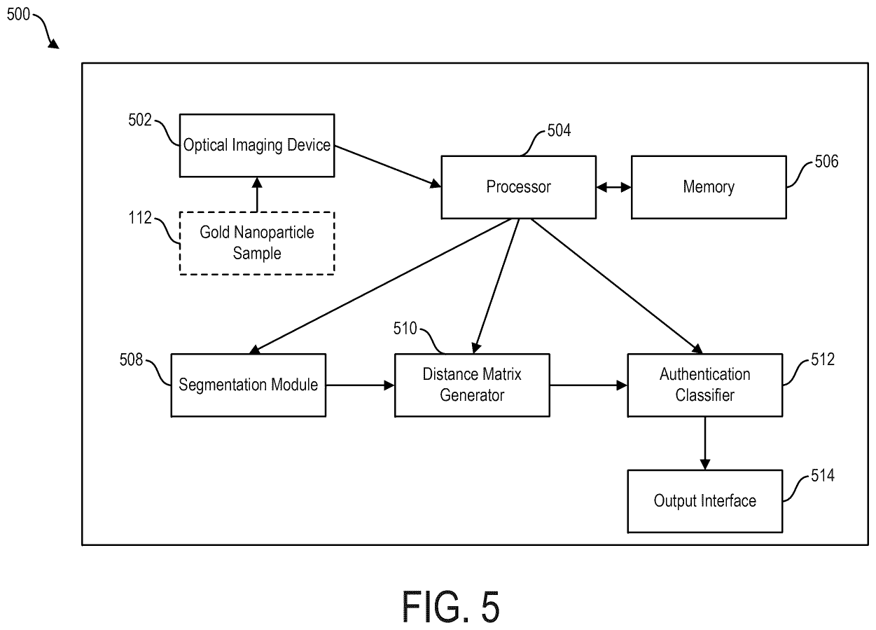

FIG. 5 illustrates a block diagram of an example authentication system according to an example embodiment of the present disclosure.

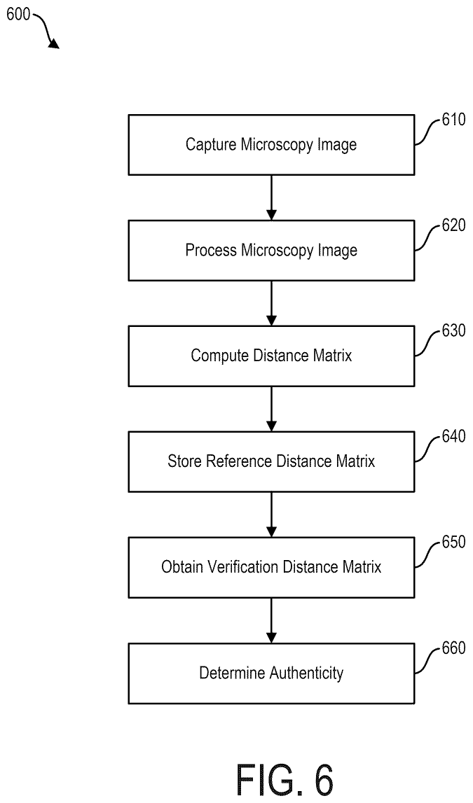

FIG. 6 illustrates a flow chart of an example method for authenticating semiconductor devices according to an example embodiment of the present disclosure.

### DETAILED DESCRIPTION

Exemplary embodiments of the present disclosure will be described more fully hereinafter with reference to the accompanying drawings, in which some, but not all, embodiments of the present disclosure are shown. Indeed, the present disclosure may be embodied in many different forms and should not be construed as limited to the exemplary embodiments set forth herein; rather, these embodiments are provided so that this disclosure will satisfy applicable legal requirements. Like reference numerals refer to like elements throughout.

Embodiments of the present disclosure relate to systems and methods for authenticating semiconductor devices using physical unclonable functions (PUFs) formed by randomly distributed gold nanoparticles. The authentication method addresses the dual challenges faced by the global chip industry: a shortage of new chips and a surge of counterfeit chips valued at $75 billion, which introduce substantial risks of malfunction and unwanted surveillance.

The semiconductor industry has grown into a $500 billion global market over several decades. However, the semiconductor fabrication pipeline has become fragmented, inadvertently giving rise to a $75 billion counterfeit chip market that jeopardizes safety and security across multiple sectors. To address this issue, embodiments of the present disclosure provide systems and methods for detecting counterfeit or tampered semiconductor devices using physical unclonable functions based on random arrays of gold nanoparticles.

Referring now to FIG. 1, a physical unclonable function (PUF) sampling process 100 is illustrated. The PUF sampling process 100 comprises four stages, including a system state preparation step 102, a PUF measurement step 104, a system tampering step 106, and a PUF verification step 108.

In the system state preparation step 102, a semiconductor device 110 is prepared with a distinctive physical signature. Semiconductor device 110 includes a substrate 114 on which a plurality of plasmonic nanoparticles such as gold nanoparticles 112 are disposed. The plurality of gold nanoparticles 112 are randomly distributed on the substrate 114, creating a unique pattern that is physically unclonable. This random distribution of the plurality of gold nanoparticles 112 occurs during fabrication and serves as the basis for the physical unclonable function.

The spatial distribution of the plurality of gold nanoparticles 112 on the substrate 114 follows a uniform distribution where the position coordinates rᵢ of each nanoparticle are uniformly distributed within a unit square:

$${r}_{i} ∼ {U [ 0 , 1 ]}^{2}$$

While the positions follow a uniform distribution, the radii ρᵢ of the plurality of gold nanoparticles 112 follow a normal distribution with a mean radius μ_{ρ} and standard deviation σ_{ρ}:

$${ρ}_{i} ∼ N ( {μ}_{ρ} , {σ}_{ρ} )$$

In some embodiments, μ_{ρ} is approximately 0.006 units, and σ_{ρ} is approximately 0.004 units, where the units are relative to the normalized substrate dimensions. In some embodiments, the plurality of gold nanoparticles 112 have diameters ranging from 10 nm to 100 nm and are distributed with a density between 50 and 150 nanoparticles per square millimeter.

The substrate 114 is typically part of the semiconductor device packaging material. In some embodiments, the substrate 114 comprises a semiconductor packaging material having the plurality of gold nanoparticles 112 embedded at or near a surface of the packaging material. The substrate 114 serves as a physical platform for the plurality of gold nanoparticles 112 and provides structural integrity to the physical unclonable function.

In the PUF measurement step 104, an optical imaging device 118 captures microscopy images of the plurality of gold nanoparticles 112 on the substrate 114. The optical imaging device 118 is configured to capture dark-field microscopy images, which provide high contrast between the plurality of gold nanoparticles 112 and the background of the substrate 114. The dark-field imaging technique enhances the visibility of the nanoparticles by illuminating them at an angle, causing them to appear as bright spots against a dark background.

The measurements from the PUF measurement step 104 are processed to extract the positions and radii of the plurality of gold nanoparticles 112, which together form a system state x={r, ρ}, where r represents the positions and ρ represents the radii. This system state follows a distribution p(x) determined by the fabrication process. The measurements are recorded and stored in a reference database 120 as a set M={m₀, . . . , m_{|M|-1}}, where each measurement m is associated with the system state x according to a distribution p(m|x).

The system tampering step 106 represents a phase where the semiconductor device 110 undergoes changes that might affect the arrangement of the plurality of gold nanoparticles 112. During this step, the system state x evolves to a new state x′, either through natural degradation governed by a distribution qₙ(x′|x) or through adversarial tampering governed by a distribution qₐ(x′|x).

In the case of natural degradation, the positions of the plurality of gold nanoparticles 112 undergo small random displacements due to thermal fluctuations or other environmental factors. These displacements can be modeled as Gaussian translations:

$${r}^{′} = r + {r}_{Δ} where {r}_{Δ} ∼ N ( 0 , {σ}_{Δ} )$$

In the case of adversarial tampering involving substrate tearing 116, the displacement of each nanoparticle is modeled based on its distance from the tear line. The displacement is perpendicular to the tear line and inversely proportional to the square root of the distance. For a tear along direction α with tearing coefficient w, the displacement is given by:

displacement=w/√/ [symbol] rᵢ,αᵢ [symbol] |; where [symbol] rᵢ,αᵢ [symbol] represents the perpendicular distance from the nanoparticle position rᵢ to the tear line direction αᵢ.

The PUF verification step 108 involves re-measuring the positions and radii of the plurality of gold nanoparticles 112 after the system has potentially undergone tampering. New measurements m′˜p(m′|x′) are taken and stored in a verification database M′={m′₀, . . . , m′_{M|-1}}. These new measurements are then compared with the reference data stored in the database 120 to determine whether the semiconductor device 110 has been tampered with.

The comparison between the initial and subsequent measurements involves analyzing the changes in the distance matrix D constructed from the positions of the plurality of gold nanoparticles 112. For nanoparticles i and j with positions rᵢ and rⱼ, the distance matrix element Dᵢⱼ is defined as: Dᵢⱼ=d(rᵢ, rⱼ); where d(rᵢ, rⱼ) is the Euclidean distance between the positions. By comparing the initial distance matrix D with the post-tampering distance matrix D′, the authentication system determines the independent Bernoulli variable β that the changes observed are the result of adversarial tampering rather than natural degradation:

$$β ∼ B ( Bernoulli distribution )$$

where β=0 indicates natural degradation and β=1 indicates adversarial tampering.

By leveraging the random distribution of the plurality of gold nanoparticles 112 on the substrate 114, the process creates a unique physical signature that is difficult to replicate. The process further enables the detection of both natural degradation and adversarial tampering through careful analysis of changes in the spatial arrangement of the plurality of gold nanoparticles 112. The random distribution of the plurality of gold nanoparticles 112 creates a practically infinite number of possible configurations, making it extremely difficult for an adversary to create an identical pattern. Furthermore, the process is capable of distinguishing between natural degradation and adversarial tampering, enabling accurate authentication even after the semiconductor device 110 has been exposed to normal environmental conditions.

While the description focuses on gold nanoparticles for clarity, embodiments of the present disclosure encompass various plasmonic materials for forming the physical unclonable function. Plasmonic materials exhibit surface plasmon resonances that enable strong light-matter interactions, making them suitable for optical authentication applications.

In some embodiments, the plurality of nanoparticles comprises metals such as gold (Au), copper (Cu), aluminum (Al), or silver (Ag). Each metal exhibits distinct plasmonic properties across different wavelengths, enabling material-specific optical signatures that enhance authentication security. Gold nanoparticles provide stability and strong optical scattering in the visible spectrum. Copper nanoparticles offer cost advantages while maintaining good plasmonic properties. Aluminum nanoparticles extend plasmonic responses into the ultraviolet range, while silver provides the strongest plasmonic enhancement but may require protective coatings.

In some embodiments, the plurality of nanoparticles comprises plasmonic ceramics such as titanium nitride (TiN). Plasmonic ceramics offer advantages including high temperature stability, chemical inertness, and compatibility with semiconductor processing techniques, making them particularly suitable for harsh operating environments where traditional metals might degrade.

In some embodiments, the plurality of nanoparticles comprises transparent conducting oxides (TCOs) such as hafnium oxide (HfO), aluminum-doped zinc oxide (AZO), or gallium-doped zinc oxide (GZO). TCOs provide unique optical properties while maintaining transparency in certain wavelength ranges, enabling covert authentication applications where visible markings are undesirable.

In some embodiments, combinations of different plasmonic materials are employed to create multi-material authentication signatures. Such combinations increase the complexity of counterfeiting by requiring adversaries to replicate multiple distinct material systems simultaneously. The different materials may be distinguished through spectroscopic measurements, polarization-dependent responses, or wavelength-specific imaging techniques. For example, a substrate may include both gold and aluminum nanoparticles, where gold particles provide strong visible light scattering while aluminum particles respond primarily to ultraviolet illumination.

Referring now to FIG. 2, a distance matrix extraction process 200 is illustrated according to an example embodiment of the present disclosure. The distance matrix extraction process 200 forms a basis for the authentication method by transforming the visual information of gold nanoparticles into a structured mathematical representation.

The process begins with an original dark-field image 202, capturing the plurality of gold nanoparticles 112 against a dark background 214. The dark-field microscopy technique used to capture this image enhances the contrast between the plurality of gold nanoparticles 112 and the background 214, wherein the plurality of gold nanoparticles 112 appears as bright spots due to their light-scattering properties. In some embodiments, the original dark-field images are captured at a magnification of 1500× to ensure adequate resolution for detecting individual nanoparticles.

The original dark-field image 202 is passed to a segmentation module 204, which processes the image to separate the nanoparticle regions from the background 214. The segmentation module 204 employs semantic segmentation to classify each pixel in the image as either belonging to a nanoparticle or the background.

In some embodiments, the segmentation module 204 utilizes a machine learning model specifically configured for nanoparticle identification. The segmentation module 204 includes a convolutional neural network architecture with an encoder-decoder structure that progressively downsamples the input image through multiple convolutional layers, followed by upsampling to produce pixel-wise classification. This architecture enables the model to capture both local features (such as edges and intensity variations) and global context (such as typical nanoparticle sizes and distribution patterns).

In some embodiments, the optical imaging device 118 employs polarized illumination to enhance the detection of the plurality of nanoparticles. The polarized illumination may comprise linear polarization, circular polarization, or combinations thereof. Polarized illumination increases the optical contrast between the nanoparticles and the substrate background by exploiting the anisotropic scattering properties of the nanoparticles, thereby improving the authentication process under varying environmental conditions. Linear polarization can enhance the detection of nanoparticles with non-spherical shapes, while circular polarization provides more uniform illumination for spherical particles.

The optical imaging device 118 may employ various illumination modalities to enhance nanoparticle detection and characterization. In some embodiments, the optical imaging device 118 provides continuous wave (CW) illumination for stable imaging conditions and consistent light intensity. In other embodiments, pulsed illumination is employed to reduce thermal effects, minimize photodamage to the substrate, and enable time-resolved measurements. Pulsed illumination also allows for higher peak intensities without excessive heating, which can improve signal-to-noise ratios.

The optical imaging device 118 may further be configured to capture spectroscopic responses across multiple wavelengths, enabling more precise discrimination between nanoparticles of different sizes and materials based on their distinctive optical signatures. Spectroscopic measurements can distinguish between nanoparticles with similar sizes but different materials, or identify size variations within a single material type. This spectroscopic capability enhances the authentication security by providing additional dimensions of information beyond spatial positioning.

The machine learning model may be trained on a dataset of 10,000 dark-field images, wherein 2,400 nanoparticle bounding boxes are extracted from 40 source images. These training images include various transformations such as rotation, shear, and additive noise to maximize the diversity of the training set and improve the model's generalization capabilities. The training process uses a binary cross-entropy loss function to optimize the model's parameters

In some embodiments, the segmentation module 204 achieves a binary cross-entropy loss of 10⁻³ on the validation set, corresponding to approximately 99% accuracy in pixel-wise classification. This high accuracy enables for reliable identification of the plurality of gold nanoparticles 112, particularly for nanoparticles with smaller radii that are more difficult to distinguish from background noise.

The segmentation model enforces a minimum pattern radius of 0.5 μm to discern the nanoparticles from noise, as smaller patterns cannot be reliably verified to be gold nanoparticles. This threshold is chosen based on the optical resolution limits of the dark-field microscopy system and the typical size distribution of the gold nanoparticles used in the physical unclonable function.

In some embodiments, the segmentation module 204 implements a ResNet-based attention convolutional neural network that processes images in 27 milliseconds per image on a graphics processing unit, representing a speed improvement over conventional unsupervised segmentation methods that require approximately 24 minutes for 1,000 images. This computational efficiency enables rapid authentication of semiconductor devices, with segmentation results available within 100 milliseconds of receiving the microscopy image.

The segmentation process yields a segmented image 206 in which the plurality of gold nanoparticles 112 are clearly distinguished from the background 214. The segmented image 206 preserves the spatial distribution of the nanoparticles while removing noise and enhancing the visibility of individual particles.

Following segmentation, the segmented image 206 undergoes clustering by a clustering module 208. The clustering module 208 applies labeled clustering algorithms to determine the positions and radii of each of the plurality of gold nanoparticles 112. This process identifies the centers of mass 218 of the nanoparticles, representing their positions in two-dimensional space. The clustering algorithm groups adjacent pixels belonging to the same nanoparticle and calculates the centroid position of each cluster.

For each identified nanoparticle i, the position is denoted as rᵢ and the radius as ρᵢ. The positions are represented as two-dimensional vectors in a normalized coordinate system:

$${r}_{i} = ( {x}_{i} , {y}_{i} ) where {x}_{i} , {y}_{i} ∈ [ 0 , 1 ]$$

The radii ρᵢ are calculated based on the area of the corresponding nanoparticle cluster, assuming approximately circular nanoparticle projections in the image. The radius is derived using the formula:

$${ρ}_{i} = \sqrt{\frac{{A}_{i}}{π}} ;$$

where Aᵢ is the area of the nanoparticle cluster in pixels, converted to physical units based on the microscope's calibration.

Then, in the distance matrix extraction process 200 is the generation of a distance matrix 210 based on the positions of the plurality of gold nanoparticles 112. The distance matrix 210 is visualized with connecting lines 220 between the nanoparticle positions, representing the pairwise distances between nanoparticles.

The distance matrix D is constructed by calculating the Euclidean distance between each pair of nanoparticles:

Dᵢⱼ=d(rᵢ,rⱼ)=∥rᵢ−rⱼ∥²; where ∥rᵢ−rⱼ∥² is the Euclidean norm of the difference between positions rᵢ and rⱼ.

The distance matrix D exhibits several properties that make it suitable for authentication purposes. First, it is rotationally and translationally invariant, meaning that the matrix remains unchanged if the entire pattern of nanoparticles is rotated or translated as a whole. This property makes the authentication process robust against orientation changes during imaging.

Second, the distance matrix D is renormalizable, enabling consistent comparison between different scales of images. In some embodiments, the distance matrix is normalized by dividing all elements by the maximum distance observed in the matrix:

$${\hat{D}}_{ij} = {D}_{ij} / max ( D )$$

Third, the distance matrix D is simple to compute using computer vision techniques, making it practical for implementation in authentication systems with varying computational resources.

The visualization of the distance matrix 210 in FIG. 2 shows a minimum spanning tree for clarity, connecting each nanoparticle to its nearest neighbors. However, the actual distance matrix contains all pairwise distances between the plurality of gold nanoparticles 112, forming a complete graph representation of their spatial relationships.

In some embodiments, to manage computational complexity for large numbers of nanoparticles, the distance matrix is computed based on a subset of the plurality of gold nanoparticles 112. This subset comprises between 50 and 100 nanoparticles having the largest radii, selected to focus on the most prominent and reliably detectable particles.

The distance matrix extraction process 200 transforms the visual information from the original dark-field image 202 into a structured mathematical representation that captures the unique spatial arrangements of the plurality of gold nanoparticles 112. This transformation enables the authentication process, as it provides a compact and invariant representation of the physical unclonable function formed by the nanoparticles.

The distance matrix D serves as a signature for the semiconductor device, encoding the unique pattern of the plurality of gold nanoparticles 112 in a form that enables mathematical comparison between different measurements. This mathematical representation enables the detection of changes in the nanoparticle pattern, whether resulting from natural degradation or adversarial tampering, as will be described in relation to subsequent figures.

Referring now to FIG. 3A, a machine learning authentication flow 300 is illustrated according to an example embodiment of the present disclosure. The authentication flow 300 demonstrates how the system distinguishes between natural degradation and adversarial tampering of semiconductor devices incorporating physical unclonable functions.

The authentication flow 300 begins with a fabrication step 302, where a semiconductor device 110 with a plurality of gold nanoparticles 112 on a substrate 114 is manufactured. The fabrication process involves the random distribution of the plurality of gold nanoparticles 112 on the substrate 114, creating a unique spatial arrangement that serves as the basis for the physical unclonable function. The fabrication follows the distribution patterns described in relation to FIG. 1, with positions uniformly distributed and radii following a normal distribution.

Following the fabrication step 302, the semiconductor device 110 undergoes a pre-tamper measurement step 308, where the initial state of the plurality of gold nanoparticles 112 is recorded. This initial measurement establishes a baseline for later authentication by capturing the original spatial arrangement of the nanoparticles before any degradation or tampering occurs. The pre-tamper measurement step 308 utilizes dark-field microscopy to capture images of the plurality of gold nanoparticles 112, followed by segmentation and position extraction as described in relation to FIG. 2.

During the pre-tamper measurement step 308, a pre-tamper distance matrix 324 is constructed from the positions of the plurality of gold nanoparticles 112. This distance matrix 324 represents the pairwise distances between all nanoparticles in their initial state, forming a mathematical signature of the original physical unclonable function. The pre-tamper distance matrix 324 is stored in memory for later comparison during the authentication process.

After the initial measurement, the semiconductor device 110 follows one of two paths: a natural degradation step 304 or an adversarial tamper step 306. These two paths represent the different types of changes that the semiconductor device 110 might experience during its lifecycle.

In the natural degradation step 304, the semiconductor device 110 experiences normal environmental conditions and wear over time. These conditions include thermal fluctuations, packaging abrasions, and exposure to humidity. Natural degradation causes small, random displacements in the positions of the plurality of gold nanoparticles 112, modeled as Gaussian translations:

$${r}^{′} = r + {r}_{Δ} , where {r}_{Δ} ∼ N ( 0 , {σ}_{Δ} )$$

In some embodiments, the standard deviation σ_{Δ} for natural degradation is set to 0.05 times the image width, representing a relatively small displacement that preserves the overall structure of the nanoparticle pattern. These small displacements reflect the minor physical changes that occur through normal handling and environmental exposure of the semiconductor device 110.

In the adversarial tamper step 306, the semiconductor device 110 is deliberately modified in an attempt to compromise its functionality or create a counterfeit device. A common form of adversarial tampering is substrate tearing 116, where the substrate 114 is physically cut or torn, displacing the plurality of gold nanoparticles 112 in the vicinity of the tear.

As shown in FIG. 3B, low tearing coefficient example (w=0.01) showing normalized x-y coordinates with gold nanoparticles and a red tear line with displacement vectors. The adversarial tampering through substrate tearing 116 is modeled mathematically as a displacement of nanoparticles perpendicular to the tear line, with the magnitude of displacement inversely proportional to the square root of the distance from the tear. For a tear along direction α with tearing coefficient w, the displacement of a nanoparticle at position rᵢ is given by:

$$displacement = w / \sqrt{\vert 〈 {r}_{i} , {α}_{i} 〉 \vert} ;$$

where [symbol] rᵢ, αᵢ [symbol] represents the perpendicular distance from the nanoparticle position rᵢ to the tear line direction αᵢ.

The tearing coefficient w determines the severity of the displacement. A smaller tearing coefficient, such as w=0.01 shown in the chart above, results in minor displacements that are difficult to distinguish from natural degradation. These displacements are subtle but follow a characteristic pattern perpendicular to the tear line, with nanoparticles moving away from the line in opposite directions on either side of the tear.

As shown in FIG. 3C, high tearing coefficient example (w=0.05) showing normalized x-y coordinates with gold nanoparticles and a red tear line with more pronounced displacement vectors. A larger tearing coefficient, such as w=0.05 shown in the chart above, creates more pronounced displacements, making the tampering more evident. This chart illustrates how a higher tearing coefficient leads to more significant nanoparticle movements, particularly for nanoparticles close to the tear line. The distinctive pattern of these displacements provides a signature that can be detected during authentication.

Another form of adversarial tampering is refilling, where an adversary attempts to replace the nanoparticles in the torn region with new nanoparticles to mask the tampering. In refilling operations, the adversary introduces new nanoparticles in an attempt to recreate a pattern similar to the original distribution. However, the random nature of the original nanoparticle distribution makes it extremely difficult to recreate exactly the same pattern, leaving detectable differences in the spatial relationships between nanoparticles.

As shown in FIG. 3C, normalized expected distance graph showing three lines: natural degradation, tear without filling, and tear with filling plotted against tearing coefficient on the x-axis and normalized expected distance on the y-axis. The chart above compares the normalized expected distances between nanoparticles under different scenarios: natural degradation tearing without filling, and tearing with filling. As shown in the graph, natural degradation results in relatively small, uniform changes in the expected distances between nanoparticles. Tearing without filling creates a characteristic increase in the expected distances as the tearing coefficient increases. Tearing with filling attempts to maintain the original expected distances but still exhibits detectable differences from natural degradation, particularly as the tearing coefficient increases.

Referring back to FIG. 3A, following either the natural degradation step 304 or the adversarial tamper step 306, the semiconductor device 110 undergoes segmentation in step 314 and distance matrix creation in step 316, following the same process described in relation to FIG. 2. The segmentation step 314 extracts the positions and radii of the plurality of gold nanoparticles 112 from the post-tamper images, while the distance matrix creation step 316 constructs the appropriate distance matrices based on the pairwise distances between nanoparticles.

This sequence of steps will create both pre-tamper and post-tamper measurements. These measurements capture the current state of the plurality of gold nanoparticles 112 after potential degradation or tampering. The post-tamper measurements include a post-tamper measurement (natural) step 310 for devices that have undergone natural degradation, and a post-tamper measurement (adversarial) step 312 for devices that have been deliberately tampered with.

The post-tamper measurement (natural) step 310 results in a post-tamper natural distance matrix 326, which represents the pairwise distances between nanoparticles after natural degradation. Similarly, the post-tamper measurement (adversarial) step 312 produces a post-tamper adversarial distance matrix 328, representing the pairwise distances after adversarial tampering.

The pre-tamper distance matrix 324 and the post-tamper distance matrices (326 or 328) are then processed by a discriminator component 318, which analyzes the differences between the matrices to determine whether the changes are the result of natural degradation or adversarial tampering. The discriminator component 318 is trained on a dataset of synthetic tampering examples, covering various tearing coefficients and refilling strategies.

The discriminator component 318 produces an authentication decision output 320, represented as β\hat{ }, which indicates the probability that the semiconductor device 110 has been adversarially tampered with. The output β\hat{ } follows a Bernoulli distribution:

β\hat{ }˜B; where β\hat{ }=0 indicates natural degradation and β\hat{ }=1 indicates adversarial tampering.

In some embodiments, the discriminator component 318 employs multiple distance metrics to evaluate differences between the reference distance matrix and the verification distance matrix. These metrics include at least one of: a Hausdorff distance metric, a Procrustes distance metric, or an average-Hausdorff distance metric.

The Hausdorff distance metric H measures the maximum Euclidean distance between each point in one set and its nearest neighbor in the other set:

$$H ( r , {r}^{′} ) = max [ min d ( {r}_{i} , {r}_{j}^{′} ) ]$$

The Procrustes distance metric P accounts for rotational, translational, and scaling discrepancies by finding the optimal alignment matrix A that minimizes the sum of squared distances:

$$P ( r , {r}^{′} ) = \sum {d ( A {r}_{i} , {r}_{i}^{′} )}^{2}$$

The average-Hausdorff distance metric AHD provides a more robust measure by considering all nearest neighbors rather than just the maximum:

$$AHD ( r , {r}^{′} ) = ( 1 / \vert r \vert ) \sum [ min d ( {r}_{i} , {r}_{j}^{′} ) ]$$

While these analytical metrics provide baseline capabilities for authentication, the discriminator component 318 enhances their performance through machine learning techniques, as will be described in relation to FIG. 4.

The machine learning authentication flow 300 provides a systematic approach to distinguishing between natural degradation and adversarial tampering of semiconductor devices with physical unclonable functions. By analyzing the changes in the spatial arrangement of the plurality of gold nanoparticles 112 between pre-tamper and post-tamper measurements, the system is able to identify patterns characteristic of deliberate tampering, such as substrate tearing 116 or refilling operations.

The authentication flow 300 addresses the challenge of distinguishing between legitimate semiconductor devices that have undergone normal wear and counterfeit devices that have been deliberately tampered with. This capability enables the maintenance of the security and integrity of semiconductor supply chains, where counterfeit devices pose risks to system functionality and security.

In some embodiments, the authentication flow 300 achieves detection accuracy of over 97% for adversarial tampering, even under difficult conditions where the tearing coefficient is small or refilling operations have been attempted. This high accuracy is achieved through the detailed analysis of spatial relationships between nanoparticles, which capture subtle changes in the nanoparticle pattern that are characteristic of different types of tampering.

Referring now to FIG. 4, a Residual, Attention-based Processing of Tampered Optical Responses (RAPTOR) architecture 400 is illustrated according to an example embodiment of the present disclosure. The RAPTOR architecture 400 represents the internal structure and processing flow of the discriminator component 318 shown in FIG. 3.

The RAPTOR architecture 400 takes as input the pre-tamper distance matrices 324 and the post-tamper distance matrices, which include both natural degradation matrices 326 and adversarial tampering matrices 328. The pre-tamper input includes a distance matrix D 430 representing the spatial relationships between the plurality of gold nanoparticles 112, and pre-tamper nanoparticle radii ρ 406 representing the sizes of the nanoparticles. Similarly, the post-tamper input includes a distance matrix D′ 432 and post-tamper nanoparticle radii ρ′ 408.

The distance matrices 430 and 432 are represented as 56×56 tensors. A tensor is a mathematical object that generalizes vectors and matrices to higher dimensions—in this context, a 56×56 tensor is a two-dimensional array where each element Dᵢⱼ represents the Euclidean distance between nanoparticles i and j. The radii vectors 406 and 408 are represented as 56×1 tensors (equivalent to vectors), where each element ρᵢ represents the radius of nanoparticle i.

The RAPTOR architecture 400 begins its processing with a soft weight generation component 410, implemented as an L₂ Norm module. The L₂ Norm, also known as the Euclidean norm, measures the straight-line distance between two points in a multidimensional space. For each nanoparticle i in the pre-tamper measurement, the L₂ Norm module calculates the distance to each nanoparticle j in the post-tamper measurement.

The computed distances are then processed by a sigma operation 436, which applies a softmax normalization function. The softmax function is a mathematical operation commonly used in machine learning to convert a vector of numerical values into a probability distribution. It exponentially scales each input value and then normalizes them to ensure they sum to 1.

The Soft Weights component 411 takes the normalized weights from the sigma operation 436 and prepares them for application to the distance matrices. The softweight matrix is then applied to the post-tamper distance matrix D′ 432 through a circle operation 438, which represents the Hadamard product.

The weighted distance matrices are then processed by the Attention component 412, which integrates the weighted distances across all nanoparticles. Attention mechanisms in machine learning are configured to focus on the most relevant parts of the input data, mimicking the human ability to concentrate on specific information while ignoring irrelevant details.

The output of the Attention component 412 is combined with the original distance matrices D 430 and D′ 432 and processed by the Resnet Encoder component 414. ResNet (Residual Network) is a type of neural network architecture that introduces “skip connections” or “shortcuts” that bypass one or more layers in the network.

The extracted features from the Resnet Encoder 414 are integrated by a Concat component 416. The Concat (concatenation) component 416 combines or concatenates the feature vectors from different processing streams into a single, larger feature vector. This concatenation operation preserves all the information from each input stream while combining them into a unified representation that subsequent layers can process. In the RAPTOR architecture, the Concat component 416 merges the features learned by different parts of the network, ensuring that the authentication decision has access to all relevant information about the nanoparticle patterns.

The concatenated features then pass through a series of processing layers shown on the right side of the architecture diagram. First, the features pass through a 32×56×56 dimensional representation, which is then transformed into a 64×28×28 representation through downsampling and feature extraction. In some embodiments, different dimensions may be used for the feature to pass through.

The integrated features are processed through Attention layers 418, which perform another round of attention-based filtering to focus on the most relevant features for authentication. These Attention layers 418 further refine the network's focus, helping it distinguish between changes due to natural degradation and those resulting from adversarial tampering.

Following the Attention layers 418, the features are processed by a Max Pool layer 420, which performs dimensionality reduction by selecting the maximum value from each region of the feature maps. Max pooling helps retain the most noticeable information while reducing computational complexity and providing some invariance to small translations in the input data.

After max pooling, the features undergo a Flatten operation 424, which converts the multi-dimensional feature representation into a one-dimensional vector. In the diagram, this flattening operation transforms the 64×28×28 representation into a single vector of 64 dimensions. This flattened representation is then passed to a fully connected layer.

The final output of the RAPTOR architecture 400 is an authentication decision output 320, represented as β\hat{ }, which indicates the probability that the semiconductor device has been tampered with adversarially rather than experiencing natural degradation. A value of β\hat{ } close to 0 suggests natural degradation, while a value close to 1 indicates adversarial tampering.

The training of the RAPTOR architecture 400 uses a supervised learning approach with a binary cross-entropy loss function, gradually improving the network's ability to accurately classify different types of changes in nanoparticle patterns. In experimental evaluations, the architecture demonstrates a 97.6% accuracy in distinguishing between natural degradation and adversarial tampering, significantly outperforming traditional distance metric approaches.

### Example System Architecture

Referring now to FIG. 5, a block diagram of an example authentication system 500 is illustrated according to various embodiments of the present disclosure. The authentication system 500 provides for the detection of counterfeit or tampered semiconductor devices using physical unclonable functions based on random arrays of gold nanoparticles. The system 500 enables the analysis of microscopy images to determine the authenticity of semiconductor devices through comparison of nanoparticle patterns before and after potential tampering.

The illustrated authentication system 500 includes an optical imaging device 502, a processor 504, memory 506, a segmentation module 508, a distance matrix generator 510, an authentication classifier 512, and an output interface 514. The authentication system 500 may comprise any number of different modules or components, and each of these may include any device or means embodied in either hardware, software, or a combination of hardware and software configured to perform one or more corresponding functions described herein.

The optical imaging device 502 is configured to capture microscopy images of a plurality of gold nanoparticles disposed on a substrate of a semiconductor device. In some embodiments, the optical imaging device 502 comprises a dark-field microscope that enhances the visibility of the gold nanoparticles against the background of the substrate. The optical imaging device 502 provides high-resolution images that clearly show the spatial arrangement of the plurality of gold nanoparticles, enabling precise measurement of their positions and radii. In some embodiments, the optical imaging device 502 employs polarized illumination to enhance the detection of the plurality of nanoparticles. The polarized illumination may comprise linear polarization, circular polarization, or combinations thereof, increasing optical contrast and detection robustness. The optical imaging device 502 may also provide illumination comprising continuous wave (CW) illumination, pulsed illumination, or both, and may be configured to capture spectroscopic responses of the plurality of nanoparticles to enable discrimination between nanoparticles of different radii and materials.

The processor 504 may be any means configured to execute various programmed operations or instructions stored in a memory device (e.g., memory 506), such as a device or circuitry operating in accordance with software or otherwise embodied in hardware or a combination of hardware and software (e.g., a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor 504 as described herein. In this regard, the processor 504 may be configured to analyze electrical signals communicated thereto to provide or receive image data from the optical imaging device 502 and process this data to authenticate semiconductor devices.

The processor 504 controls the operation of the authentication system 500 and executes the instructions that implement the authentication process. The processor 504 processes the microscopy images to identify the positions and radii of the plurality of gold nanoparticles, computes distance matrices based on these positions and determines the authenticity of the semiconductor device by comparing the reference distance matrix with the verification distance matrix. In some embodiments, the processor 504 includes multiple processing cores or units to handle the computational demands of the image processing and machine learning algorithms used in the authentication process.

In some embodiments, the processor 504 is further configured to implement signal processing to enhance the quality of the microscopy images. The processor 504 may be configured to perform enhancement features to improve the display characteristics of the images, filter noise or extraneous data to better analyze the nanoparticle patterns, or normalize the images to ensure consistent analysis across different lighting conditions or imaging sessions.

In some embodiments, the memory 506 includes one or more non-transitory storage or memory devices, such as, for example, volatile and/or non-volatile memory that may be either fixed or removable. The memory 506 can be configured to store instructions, computer program code, image data, and additional data such as reference distance matrices, verification distance matrices, and nanoparticle radii information in a non-transitory computer-readable medium for use by the processor 504 for enabling the authentication system 500 to carry out various functions in accordance with embodiments of the present disclosure.

The memory 506 stores the instructions that implement the authentication process, including the algorithms for image segmentation, distance matrix generation, and authentication classification. The memory 506 also stores the reference distance matrices from initial measurements of the plurality of gold nanoparticles, which are used as baselines for comparison during the authentication process. In some embodiments, the memory 506 includes a database of known tampering patterns to improve the accuracy of the authentication classifier 512.

The segmentation module 508 processes the microscopy images to identify the positions and radii of the plurality of gold nanoparticles. The segmentation module 508 implements semantic segmentation algorithms to separate the nanoparticle regions from the background in the microscopy images. In some embodiments, the segmentation module 508 employs a machine learning model, such as a convolutional neural network, trained to achieve at least 95% accuracy in identifying the plurality of gold nanoparticles in the microscopy image.

The segmentation module 508 extracts the plurality of gold nanoparticles from the microscopy image using semantic segmentation to separate nanoparticle regions from background regions and applies labeled clustering to determine the positions and radii of the plurality of gold nanoparticles. The output of the segmentation module 508 includes the coordinates of each nanoparticle center and an estimate of each nanoparticle's radius, which are passed to the distance matrix generator 510.

The distance matrix generator 510 computes distance matrices based on the positions of the identified plurality of gold nanoparticles. The distance matrix generator 510 calculates the Euclidean distances between all pairs of nanoparticles and arranges these distances in a matrix format. In some embodiments, the distance matrix generator 510 selects a subset of the plurality of gold nanoparticles based on their radii, wherein the subset comprises between 50 and 100 nanoparticles having the largest radii and computes the distance matrix based on the positions of this subset to improve computational efficiency.

The distance matrix generator 510 produces both reference distance matrices from initial measurements and verification distance matrices from subsequent measurements. These matrices capture the spatial relationships between the plurality of gold nanoparticles, providing a mathematical representation of the physical unclonable function that can be used for authentication.

The authentication classifier 512 determines the authenticity of the semiconductor device by comparing the reference distance matrix with the verification distance matrix. The authentication classifier 512 implements the Residual, Attention-based Processing of Tampered Optical Responses (RAPTOR) algorithm described in relation to FIG. 4. In some embodiments, the authentication classifier 512 includes a machine learning model that processes the reference distance matrix and the verification distance matrix to identify correlations between nanoparticle positions.

The authentication classifier 512 generates a softweight matrix by computing similarities between the radii of the plurality of gold nanoparticles in the initial measurement and the subsequent measurement and applies the softweight matrix to weight distances in the verification distance matrix prior to the comparison with the reference distance matrix. This approach prioritizes matching nanoparticles based on similarities between their size characteristics in the initial and subsequent measurements, improving the accuracy of the authentication process.

The authentication classifier 512 can detect various types of adversarial tampering, including substrate tearing, thermal tampering, physical abrasion, or substrate refilling. In some embodiments, the authentication classifier 512 employs one or more distance metrics to evaluate differences between the reference distance matrix and the verification distance matrix, the one or more distance metrics including at least one of: a Hausdorff distance metric, a Procrustes distance metric, or an average-Hausdorff distance metric.

The output interface 514 provides the authentication results to users or other systems. The output interface 514 is connected to the authentication classifier 512 and receives the authentication decision from it. In some embodiments, the output interface 514 is configured to provide an authenticity determination result within 100 milliseconds of receiving the subsequent measurement, enabling rapid authentication of semiconductor devices.

The output interface 514 may present the authentication results in various formats, such as a simple binary indication of authenticity, a probability score indicating the likelihood of tampering, or a detailed analysis of the changes detected in the nanoparticle pattern. In some embodiments, the output interface 514 includes visualization capabilities to display the nanoparticle patterns and highlight the differences between the reference and verification measurements.

The components presented in FIG. 5 may be rearranged to alter the connections between components in some embodiments. For example, in some embodiments, the segmentation module 508, distance matrix generator 510, and authentication classifier 512 may be implemented as software modules running on the processor 504 rather than as separate hardware components. Additionally, in some embodiments, the optical imaging device 502 may be directly connected to the segmentation module 508 rather than to the processor 504.

The authentication system 500 provides a comprehensive solution for semiconductor device authentication using physical unclonable functions based on randomly distributed gold nanoparticles. The system integrates optical imaging, image processing, and machine learning to create a robust authentication mechanism that is resistant to counterfeiting and tampering. The system 500 is designed to be flexible and adaptable, capable of authenticating a wide range of semiconductor devices with different physical characteristics.

### Flowchart(s) and Operation

FIG. 6 illustrates a flow chart according to an example method 600 for authenticating semiconductor devices, in accordance with various embodiments of the present disclosure. The method 600 provides a systematic approach to detecting counterfeit or tampered semiconductor devices using physical unclonable functions based on random arrays of gold nanoparticles. Various types of information may be captured, processed, and analyzed to determine the authenticity of semiconductor devices. The method 600 may be performed by a system such as the authentication system 500 described in FIG. 5, utilizing the optical imaging device 502, processor 504, memory 506, and associated components.

At operation 610, a microscopy image of a plurality of gold nanoparticles disposed on a substrate of a semiconductor device is captured. The optical imaging device 502 captures dark-field microscopy images that clearly show the randomly distributed gold nanoparticles forming a physical unclonable function (PUF). The captured image serves as the basis for the subsequent authentication process, providing a visual representation of the spatial arrangement of the plurality of gold nanoparticles on the substrate.

At operation 620, the microscopy image is processed to identify positions and radii of the plurality of gold nanoparticles. This processing involves semantic segmentation to separate nanoparticle regions from background regions, followed by labeled clustering to determine the precise positions and sizes of each nanoparticle. The processing extracts the coordinates of each nanoparticle center and an estimate of each nanoparticle's radius, which are used in subsequent operations of the authentication method.

At operation 630, a distance matrix is computed based on distances between the identified positions of the plurality of gold nanoparticles. The distance matrix is constructed by calculating the Euclidean distance between each pair of nanoparticles and arranging these distances in a matrix format. In some embodiments, a subset of the plurality of gold nanoparticles is selected based on their radii, wherein the subset comprises between 50 and 100 nanoparticles having the largest radii, and the distance matrix is computed based on the positions of this subset to improve computational efficiency. The distance matrix captures the spatial relationships between the plurality of gold nanoparticles, providing a mathematical representation of the physical unclonable function.

At operation 640, a reference distance matrix from an initial measurement of the plurality of gold nanoparticles is stored in memory. This reference matrix serves as a baseline for comparison during the authentication process, representing the original state of the physical unclonable function before any potential degradation or tampering. In some embodiments, the reference distance matrix is stored along with the corresponding nanoparticle radii information, which is used in subsequent operations to improve the accuracy of the authentication process.

At operation 650, a verification distance matrix from a subsequent measurement of the plurality of gold nanoparticles is obtained. The verification matrix represents the current state of the physical unclonable function, which may have been affected by natural degradation or adversarial tampering. The subsequent measurement follows the same process as the initial measurement, involving capturing a new microscopy image, processing the image to identify nanoparticle positions and radii, and computing a distance matrix based on these positions. The verification matrix is then compared with the reference matrix to determine the authenticity of the semiconductor device.

At operation 660, authenticity of the semiconductor device is determined by comparing the reference distance matrix with the verification distance matrix using a comparison mechanism that prioritizes matching nanoparticles based on similarities between their size characteristics in the initial and subsequent measurements. In some embodiments, the comparison mechanism employs the Residual, Attention-based Processing of Tampered Optical Responses (RAPTOR) algorithm described in relation to FIG. 4. The comparison mechanism generates a softweight matrix based on similarities between nanoparticle radii and applies this matrix to weight the distances in the verification matrix, enabling more accurate detection of tampering.

The comparison mechanism is capable of detecting various types of adversarial tampering, including substrate tearing, thermal tampering, physical abrasion, or substrate refilling. In some embodiments, the comparison mechanism employs multiple distance metrics to evaluate differences between the reference distance matrix and the verification distance matrix, the multiple distance metrics including at least one of: a Hausdorff distance metric, a Procrustes distance metric, or an average-Hausdorff distance metric. The output of the comparison mechanism is an authentication decision indicating whether the semiconductor device has been tampered with adversarially rather than experiencing natural degradation.

The method 600 may also include additional operations or variations based on specific implementation requirements. For example, in some embodiments, the method includes an operation to enhance the quality of the microscopy images through signal processing techniques before identifying nanoparticle positions and radii. Additionally, in some embodiments, the method includes an operation for selecting a subset of the plurality of gold nanoparticles based on their radii before computing the distance matrices, improving computational efficiency while maintaining authentication accuracy.

In another embodiment, the method 600 includes an operation for detecting specific types of tampering based on characteristic patterns in the nanoparticle displacements. For example, substrate tearing may be detected by identifying discontinuities in nanoparticle positions along a cut line. In contrast, substrate refilling may be detected by identifying regions with altered nanoparticle density characteristics. These specific tampering detection capabilities enhance the usefulness of the authentication method in real-world scenarios where different types of tampering attempts may occur.

Furthermore, in some embodiments, the method 600 includes an operation for providing detailed visualization of the authentication results, highlighting the differences between the reference and verification measurements and indicating the specific areas where tampering is suspected. This visualization helps users understand the basis for the authentication decision and may provide valuable information for further investigation of potentially counterfeit devices.

Method 600 of FIG. 6 is merely exemplary, and method 600 may be modified in various ways. For example, the order of operations of the method 600 may differ in other embodiments, and some of the operations of method 600 may be performed simultaneously in some embodiments. Furthermore, additional operations may be added to method 600 and certain operations may be omitted from method 600 in some embodiments.

The method 600 provides a comprehensive approach to semiconductor device authentication using physical unclonable functions based on randomly distributed gold nanoparticles. By leveraging advanced image processing and machine learning techniques, the method enables accurate detection of counterfeit or tampered devices, helping to address the challenges posed by the proliferation of counterfeit semiconductors in global supply chains.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While the detailed embodiments described herein focus on semiconductor device authentication as a primary application, it should be understood that the systems and methods of the present disclosure are not limited to the semiconductor industry. The authentication technology disclosed herein has broad applicability for authenticating various valuable products where counterfeiting poses security or safety risks. Such products may include, but are not limited to: electronic components, luxury goods, pharmaceuticals, aerospace components, automotive parts, medical devices, currency, identification documents, consumer electronics, and any other items where covert authentication is desired. The plasmonic nanoparticle-based physical unclonable functions can be integrated into packaging materials, protective coatings, labels, or structural components of these various products without affecting their primary functionality or aesthetic appearance. The covert nature of the authentication method, requiring specialized optical equipment for verification, makes it particularly suitable for high-value items where visible security features might compromise the product's design or alert counterfeiters to the presence of authentication mechanisms.

### CONCLUSION

Many modifications and other embodiments of the disclosures set forth herein will come to mind to one skilled in the art to which these present disclosures pertain, having the benefit of the teachings presented in the foregoing descriptions and the associated drawings. Therefore, it is to be understood that the embodiments of the present disclosure are not to be limited to the specific embodiments disclosed and that modifications and other embodiments are intended to be included within the scope of the present disclosure. Moreover, although the foregoing descriptions and the associated drawings describe example embodiments in the context of certain example combinations of elements and/or functions, it should be appreciated that alternative embodiments may provide different combinations of elements and/or functions without departing from the scope of the present disclosure. In this regard, for example, different combinations of elements and/or functions than those explicitly described above are also contemplated within the scope of the present disclosure. Although specific terms are employed herein, they are used in a generic and descriptive sense only and not for purposes of limitation.

1. A system for authenticating products, the system comprising:
a substrate comprising a plurality of plasmonic nanoparticles disposed thereon, wherein the plurality of plasmonic nanoparticles forms a physical unclonable function (PUF);
an optical imaging device configured to capture a microscopy image of the plurality of plasmonic nanoparticles on the substrate;
a processor; and
a memory storing instructions that, when executed by the processor, cause the processor to:
process the microscopy image to identify positions and radii of the plurality of plasmonic nanoparticles;
compute a distance matrix based on distances between the identified positions of the plurality of plasmonic nanoparticles;
store a reference distance matrix from an initial measurement of the plurality of plasmonic nanoparticles;
obtain a verification distance matrix from a subsequent measurement of the plurality of plasmonic nanoparticles; and
determine authenticity of the product by comparing the reference distance matrix with the verification distance matrix via a comparison mechanism that matches nanoparticles based on similarities between their size characteristics in the initial and subsequent measurements.

2. The system of claim 1, wherein the plurality of plasmonic nanoparticles comprises at least one of metals, plasmonic ceramics, and transparent conducting oxides.

3. The system of claim 1, wherein the memory further stores instructions that, when executed by the processor, cause the processor to
extract the plurality of plasmonic nanoparticles from the microscopy image via semantic segmentation to separate nanoparticle regions from background regions; and
apply labeled clustering to determine the positions and radii of the plurality of plasmonic nanoparticles.

4. The system of claim 3, wherein the semantic segmentation employs a machine learning model trained to achieve at least 95% accuracy in identifying the plurality of plasmonic nanoparticles in the microscopy image.

5. The system of claim 1, wherein the memory further stores instructions that, when executed by the processor, cause the processor to:
select a subset of the plurality of plasmonic nanoparticles based on their radii, wherein the subset comprises between 50 and 100 nanoparticles with the largest radii; and
compute the distance matrix based on the positions of the subset of the plurality of plasmonic nanoparticles.

6. The system of claim 1, wherein the comparison mechanism includes a machine learning model that processes the reference distance matrix and the verification distance matrix to identify correlations between nanoparticle positions.

7. The system of claim 1, wherein the memory further stores instructions that, when executed by the processor, cause the processor to
generate a softweight matrix by computing similarities between radii of the plurality of plasmonic nanoparticles in the initial measurement and the subsequent measurement; and
apply the softweight matrix to weight distances in the verification distance matrix prior to the comparison with the reference distance matrix.

8. The system of claim 1, wherein determining authenticity comprises detecting adversarial tampering types, including at least one of: substrate tearing, thermal tampering, physical abrasion, or substrate refilling.

9. The system of claim 8, wherein the memory further stores instructions that, when executed by the processor, cause the processor to detect substrate tearing by identifying discontinuities in nanoparticle positions along a cut line.

10. The system of claim 8, wherein the memory further stores instructions that, when executed by the processor, cause the processor to detect substrate refilling by identifying regions with altered nanoparticle density characteristics.

11. The system of claim 1, wherein the comparison mechanism employs one or more distance metrics to evaluate differences between the reference distance matrix and the verification distance matrix, the one or more distance metrics including at least one of: a Hausdorff distance metric, a Procrustes distance metric, or an average-Hausdorff distance metric.

12. The system of claim 1, wherein the optical imaging device is configured to illuminate the plurality of plasmonic nanoparticles by at least one of: polarized light comprising linear polarization or circular polarization, continuous wave illumination, pulsed illumination, or spectroscopic illumination across multiple wavelengths to enable discrimination between nanoparticles of different radii and materials.

13. The system of claim 1, wherein the substrate comprises a packaging material comprising the plurality of plasmonic nanoparticles embedded at or near a surface of the packaging material.

14. The system of claim 1, further comprising an output module configured to provide an authenticity determination result within 100 milliseconds of receiving the subsequent measurement.

15. A semiconductor device comprising the system of claim 1, wherein the substrate with the plurality of plasmonic nanoparticles is integrated into at least one of: a chip package, a circuit board, or a device enclosure to enable authentication of the semiconductor device.

16. A method for authenticating electronic devices, the method comprising:
capturing, by an optical imaging device, a microscopy image of a plurality of plasmonic nanoparticles disposed on a substrate of an electronic device, wherein the plurality of plasmonic nanoparticles forms a physical unclonable function (PUF);
processing, by a processor, the microscopy image to identify positions and radii of the plurality of plasmonic nanoparticles;
computing, by the processor, a distance matrix based on distances between the identified positions of the plurality of plasmonic nanoparticles;
storing, in a memory, a reference distance matrix from an initial measurement of the plurality of plasmonic nanoparticles;
obtaining, by the processor, a verification distance matrix from a subsequent measurement of the plurality of plasmonic nanoparticles; and
determining, by the processor, authenticity of the electronic device by comparing the reference distance matrix with the verification distance matrix via a comparison mechanism that prioritizes matching nanoparticles based on similarities between their size characteristics in the initial and subsequent measurements.

17. The method of claim 16, further comprising:
extracting the plurality of plasmonic nanoparticles from the microscopy image via semantic segmentation to separate nanoparticle regions from background regions; and
applying labeled clustering to determine the positions and radii of the plurality of plasmonic nanoparticles.

18. The method of claim 16, further comprising:
selecting a subset of the plurality of plasmonic nanoparticles based on their radii, wherein the subset comprises between 50 and 100 nanoparticles having the largest radii; and
computing the distance matrix based on the positions of the subset of the plurality of plasmonic nanoparticles.

19. The method of claim 16, further comprising:
generating a softweight matrix by computing similarities between radii of the plurality of plasmonic nanoparticles in the initial measurement and the subsequent measurement; and
applying the softweight matrix to weight distances in the verification distance matrix prior to the comparison with the reference distance matrix.

20. The method of claim 16, wherein determining authenticity comprises detecting adversarial tampering types including at least one of: substrate tearing, thermal tampering, physical abrasion, or substrate refilling, wherein:
substrate tearing is detected by identifying discontinuities in nanoparticle positions along a cut line; and
substrate refilling is detected by identifying regions with altered nanoparticle density characteristics.
